(19) United States
(12) Patent Application Publication
(10) Pub. No.: US 2026/0153403 A1
(43) Pub. Date: Jun. 4, 2026

(54) SYSTEM AND METHOD FOR FORMING AN ARTIFICIAL ICE LAYER CONFIGURED TO COUPLE TO A SURFACE OF AN AIRCRAFT FOR A WIND TUNNEL TEST

(71) Applicant: THE BOEING COMPANY, Arlington, VA (US)

(72) Inventors: Raymond Sungtah Chi, Renton, WA (US); Jeremiah Levi Clarke Avery, Eatonville, WA (US); Albert Bajocich, Seattle, WA (US); Christopher Andrew Konings, Lynnwood, WA (US); Dean Brian Walters, Edmonds, WA (US)

(73) Assignee: THE BOEING COMPANY, Arlington, VA (US)

(21) Appl. No.: 18/967,718

(22) Filed: Dec. 4, 2024

(51) Int. Cl. G01M 9/04; B33Y 50/00; B33Y 80/00

(52) U.S. Cl. CPC G01M 9/04; B33Y 50/00; B33Y 80/00

(57) ABSTRACT

Examples of the present disclosure provide a systema and a method for testing an aircraft within a wind tunnel. The method includes integrally forming roughness components with a substrate to provide an artificial ice layer.

### FIELD OF THE DISCLOSURE

Examples of the present disclosure generally relate to a system and a method for manufacturing or otherwise forming an artificial ice layer for scaled wind testing, and which is configured to couple to a surface of an aircraft (such as an full scale model of an aircraft, a reduced scaled model of an aircraft, or an actual actual).

### BACKGROUND OF THE DISCLOSURE

An aircraft which encounters cold and moist air may be susceptible to ice formation. Under such conditions, ice accretion on wings, turbine elements, or other surfaces can affect flight characteristics of the aircraft. Such conditions are referred to as “known icing conditions,” and intentionally entering an airspace having known icing conditions is referred to as Flight Into Known Icing, or FIKI.

Various international authorities require that an aircraft design must be certified before it can be flown under actual icing conditions. While FIKI certification takes into consideration a number of factors, one aspect of the certification process may require flight tests of the aircraft or its components in measured simulated icing conditions. Such certification test flights may require that the aircraft be flown with artificial ice shapes attached to wing and/or tail leading edges. Dry air flight tests with artificial ice shapes installed on surfaces allow performance and handling characteristics to be evaluated in stable dry air conditions with an ice shape remaining a constant. Additionally, the artificial ice shapes typically need to exhibit a defined certifiable quality of surface roughness, in order to more closely match the characteristics of accreted ice.

Currently, artificial ice shapes may be constructed on the wing itself, using three-dimensional (3D) printed additively manufactured parts. Ice shape materials may be secured to the wing surface using adhesives. Artificial surface roughness features are typically modeled as part of the ice shape and are a certifiable roughness pattern for flight testing. FIKI certification can be both time-consuming and expensive.

A known method of modeling ice formed on a wing of an aircraft includes manually applying various grit components to additively manufactured (for example three-dimensional (3D) printed) model parts, which are then attached to the wing, and tested in a wind tunnel. Such process is labor intensive, and adds significant costs and time due to the large volume of parts (such as can exceed 3000, for example).

Further, the known method of manually applying grit may also not provide a required roughness, nor match the certifiable roughness patterns used in flight testing. For example, the process of manually applying grit can be inconsistent, and can result in potential error with respect to final aerodynamic data quality, repeatability, and acceptability.

### SUMMARY OF THE DISCLOSURE

A need exists for an efficient system and method of providing the certifiable roughness to an artificial ice shape configured to be applied to a surface of an aircraft during testing, such as within a wind tunnel.

With those needs in mind, certain examples of the present disclosure provide a method for testing an aircraft within a wind tunnel. The method includes integrally forming roughness components with a substrate to provide an artificial ice layer.

In at least one example, said integrally forming includes additively manufacturing the substrate and the roughness components.

In at least one example, said integrally forming includes using a three-dimensional (3D) printer to provide the artificial ice layer.

In at least one example, the roughness components are not separately secured to (such as manually) the substrate after the substrate is formed.

The method can also include providing a digital model of an artificial ice component. In such an example, said integrally forming includes integrally forming the roughness components with the substrate according to the digital model.

The method can also include scanning, by a 3D scanner, the artificial ice layer. The method can also include receiving, by a control unit, scanned data of the artificial ice layer from the 3D scanner, and performing a quality check of the artificial ice layer by comparing the scanned data with the digital model. The method can also include showing, by the control unit, a result of the quality check on an display of a user interface. Optionally, the method may not include the scanning.

In at least one example, the method also includes securing the artificial ice layer to one or more surfaces of the aircraft. The method can also include performing a test of the aircraft within the wind tunnel.

In at least one example, the roughness components include spaced-apart roughness protrusions (for example, cones, truncated cones, and/or other shapes) outwardly extending from the substrate.

### BRIEF DESCRIPTION OF THE DRAWINGS

FIG. 1 illustrates a block diagram of a system, according to an example of the present disclosure.

FIG. 2 illustrates a block diagram of an artificial ice layer disposed on one or more surfaces of an aircraft within a wind tunnel, according to an example of the present disclosure.

FIG. 3 illustrates an isometric top view of the artificial ice layer, according to an example of the present disclosure.

FIG. 4 illustrates a flow chart of a method, according to an example of the present disclosure.

FIG. 5 illustrates a schematic block diagram of a control unit, according to an example of the present disclosure.

FIG. 6 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

As described herein, examples of the present disclosure provide a system and a method of modeling and testing ice formed on a surface (such as a wing) of an aircraft (for example, a full scaled model of an aircraft, a reduced scaled model of an aircraft, or an actual aircraft) for wind tunnel testing using additively manufactured (for example, 3D printed) model parts with integrated roughness, which replace grit currently used to represent roughness. U.S. Pat. No. 9,696,238, entitled “Systems and Methods for Icing Flight Tests,” which is hereby incorporated by reference in its entirety, discloses methods of manufacturing artificial ice shapes.

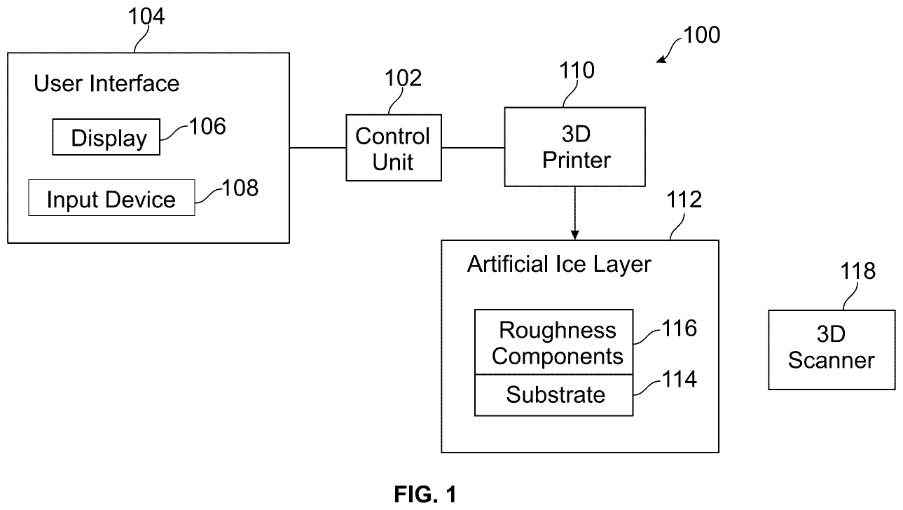

FIG. 1 illustrates a block diagram of a system 100, according to an example of the present disclosure. The system 100 includes a control unit 102 in communication with a user interface 104, such as through one or more wired or wireless connections. The user interface 104 includes a display 106 (for example, an electronic monitor, television, touchscreen, or the like) and an input device 108 (such as a keyboard, a mouse, a stylus, a touchscreen interface, and/or the like). As an example, the user interface 104 can be a computer workstation, a handheld smart device, and/or the like. The control unit 102 is also in communication with a 3D printer 110, such as through one or more wired or wireless connections.

In operation, the user interface 104 is operated to create or otherwise provide a digital model of an artificial ice component. The digital model of the artificial ice component includes roughness components, such as cones sized and spaced to scale. For example, a user can input data regarding the digital mode of the artificial ice component via the input device 108. The data can be predetermined information regarding the artificial ice component, and downloaded or uploaded to a memory. The control unit 102 receives the data regarding the digital model of the artificial ice component. The digital model includes information regarding a substrate and roughness components.

Based on the digital model, the control unit 102 operates the 3D printer 110 to form an artificial ice layer 112, which includes a substrate 114, and roughness components 116 integrally formed with the substrate 114. The substrate 114 has a shape. The substrate 114 can be a sheet, a panel, a block, a wall, and/or the like having one or more contours. The substrate 114 is configured to conform to a surface of a structure, such as wing of an aircraft. The roughness components 116 are not separately secured to the substrate 114. In at least one example, the roughness components 116 include spaced-apart protrusions (such as cones, truncated cones, pins, cylinders, and/or the like) outwardly extending from the substrate 114. Instead, the control unit 102 operates the 3D printer 110 to additively manufacture the artificial ice layer 112 having the roughness components 116 integrally formed with the substrate 114. The 3D printer 110 additively manufactures the artificial ice layer 112, such as layer-by-layer, with the substrate being additively formed as a base, and the roughness components 116 being additively formed on top of the substrate 114.

After the artificial ice layer 112 is formed by the 3D printer, a 3D scanner 118 can be used to scan the roughness components 116 to provide a quality check of the artificial ice layer 112. The 3D scanner 118 can be used to perform lot checks to verify quality compared to the 3D dataset. The 3D scanner 118 can be in communication with the control unit 102, such as through one or more wired or wireless connections. As an example, the 3D scanner 118 outputs data including scanned portions of the artificial ice layer 112 to the control unit 102. In response, the control unit 102 compares the data from the 3D scanner with the digital model, such as stored in memory, to determine if the additively manufactured artificial ice layer 112 conforms to the digital model. Optionally, the 3D scanner 118 is not in communication with the control unit 102. Also, optionally, the 3D scanner 118 may not be used to scan the roughness components 116.

In at least one example, the control unit 102 is configured to show a result of the quality check on the display 106 of the user interface 104. For example, if the artificial ice layer 112 conforms to the digital model, the control unit 102 outputs a confirmation signal to the user interface 104, which can be shown on the display 106. The confirmation signal includes information, such as can be shown on the display 106, confirming that the artificial ice layer 112 is acceptable. If, however, the artificial ice layer 112 does not conform to the digital model, the control unit 102 outputs a rejection signal to the user interface, which can be shown on the display 106. The rejection signal includes information, such as can be shown on the display 106, indicating that the artificial ice layer 112 is unacceptable.

As described, in at least one example, the control unit 102 performs a quality check of the artificial ice layer 112 by comparing the scanned data of the artificial ice layer 112 from the 3D scanner 118 with the digital model stored in memory. Alternatively, the system 100 may not scan the artificial ice layer 112 with the 3D scanner 118, and may not provide a quality check of the artificial ice layer 112.

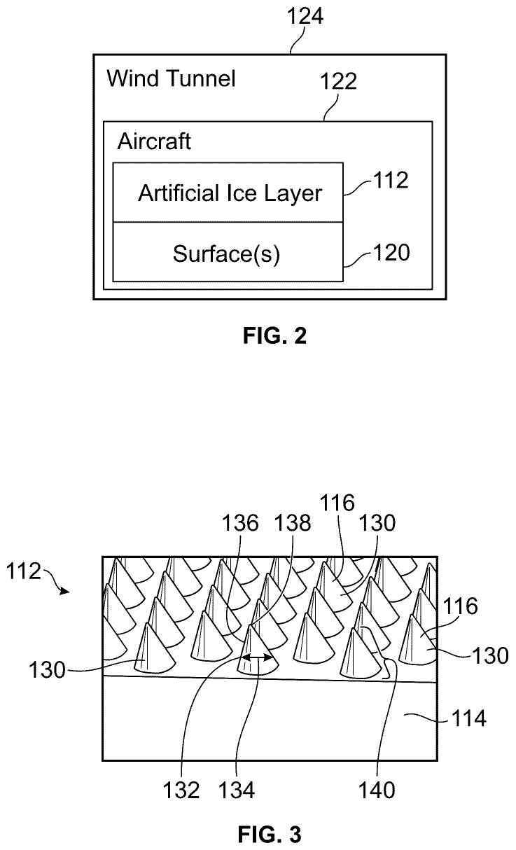

FIG. 2 illustrates a block diagram of the artificial ice layer 112 disposed on one or more surfaces 120 of an aircraft 122 within a wind tunnel 124, according to an example of the present disclosure. As noted, the aircraft 122 can be a full scale model of an aircraft. As another example, the aircraft 122 can be a reduced scale model of the aircraft. As another example, the aircraft 122 can be an actual operating aircraft. Referring to FIGS. 1 and 2, after an acceptable artificial ice layer 112 is additively manufactured by the 3D printer 110 (for example, the artificial ice layer 112 passes a quality check), the artificial ice layer 112 is secured to the surface(s) 120, such as through one or more fasteners, adhesives, and/or the like. The surface(s) 120 can include one or more exterior surfaces of a wing, a fuselage, an engine, or the like. The wind tunnel 124 is used for testing of the aircraft 122, such as aerodynamic testing of icing conditions. After the artificial ice layer 112 is secured to the surface(s) 120 of the aircraft 122, one or more tests are performed on the aircraft 122 within the wind tunnel 124.

FIG. 3 illustrates an isometric top view of the artificial ice layer 112, according to an example of the present disclosure. In at least one example, the roughness components 116 include cones 130 outwardly extending from the substrate 114. For example, each cone 130 includes a wide base 132 having a diameter 134. An intermediate body 136 upwardly extends from the base 132 and tapers to a tip 138, such as a point that is less than the diameter 134. The cones 130 have a height 140 from the base 132 to the tip 138. In at least one example, the height 140 is 0.4 millimeters (mm) or less. Optionally, the height 140 can be greater than 0.4 mm (such as 1 mm). The size, shape, and spacing of the cones 130 is predetermined, and is dictated by the digital model, as stored in memory. Each cone 130 can be sized and shaped the same. Optionally, one or more cones 130 can be sized and shaped differently than one or more other cones 130.

Referring to FIGS. 1-3, by integrating the roughness components 116 directly into the artificial ice layer 112 as additively manufactured by the 3D printer, there is no need to manually apply grit to any portion of the artificial ice layer 112, which saves time, costs, and eliminates potential inconsistencies and human error. Further, the integrated roughness components 116 automatically being formed on the artificial ice layer 112 reduces an overall number of parts needed pre-test, which further reduces costs and testing time. The integration of the roughness components 116 directly into the artificial ice layer 112, as additively manufactured by the 3D printer 110, enables on-demand print capability of parts at a test facility, allowing for further cost reductions. Examples of the present disclosure reduce manufacturing and testing costs, and as well as reduce overall cycle time for wind tunnel testing.

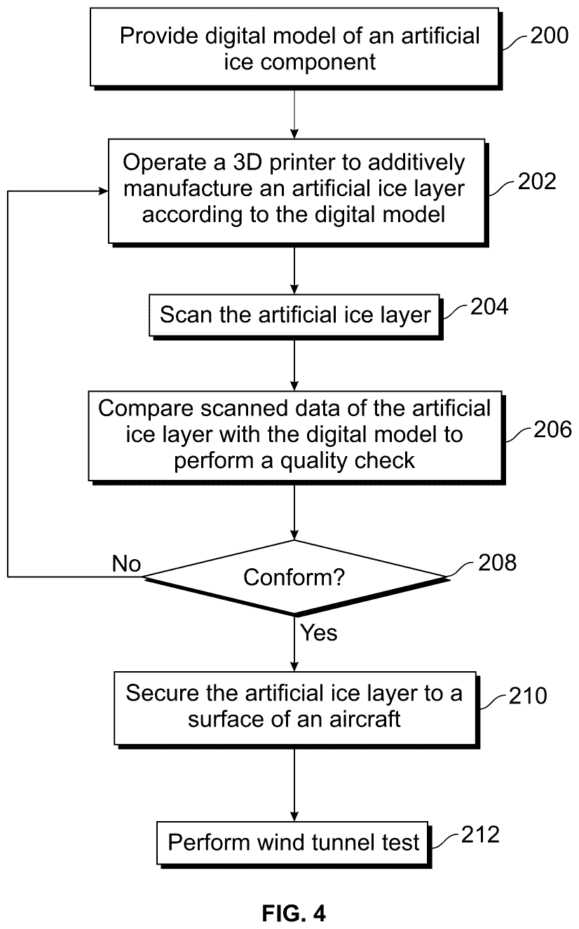

FIG. 4 illustrates a flow chart of a method, according to an example of the present disclosure. Referring to FIGS. 1-4, at 200, a digital model of an artificial ice component is provided, and stored in a memory (such as of the control unit 102). At 202, the control unit 102 operates the 3D printer 110 to additively manufacture the artificial ice layer 112 according to the digital model. The 3D printer 110 is operated to integrally form the roughness components 116 on the substrate 114 (in contrast to grit being manually applied to a formed artificial ice structure). At 204, the 3D scanner is used to scan the artificial ice layer 112, as formed by the 3D printer 110. At 206, the control unit 102 compares scanned data (from the 3D scanner 118) of the artificial ice layer with the digital model to perform a quality check of the artificial ice layer 112. At 208, the control unit 102 determines if the artificial ice layer 112 conforms to the digital model. If not, the artificial ice layer 112 is discarded, and the method returns to 202. If, however, the artificial ice layer 112 conforms to the digital model, the method proceeds from 208 to 210, at which the artificial ice layer 112 is secured to a surface 20 of the aircraft 122. The method then proceeds to 212, at which a wind tunnel test of the aircraft 122 is performed.

Optionally, the method may not include steps 204, 206, and 208. For example, the method may not include scanning or comparing scanned data with a digital model to perform a quality check.

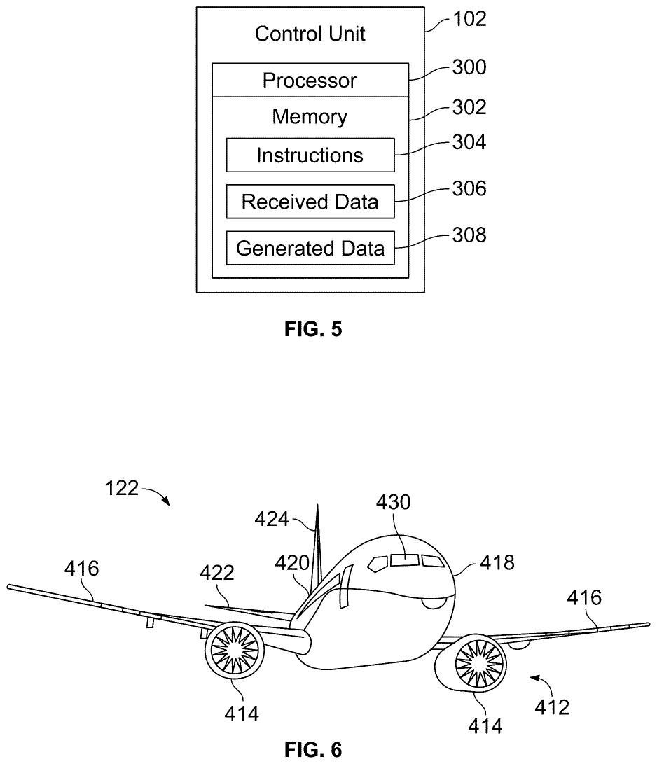

FIG. 5 illustrates a schematic block diagram of the control unit 102, according to an example of the present disclosure. In at least one example, the control unit 102 includes at least one processor 300 in communication with a memory 302. The memory 302 stores instructions 304, received data 306, and generated data 308. The control unit 102 shown in FIG. 5 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), field programmable gate arrays (FPGAs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 6 illustrates a perspective front view of an aircraft 122, according to an example of the present disclosure. As noted, the aircraft 122 can be a full scale model of an actual aircraft, a reduced scale model of the actual aircraft, or the actual aircraft itself. The aircraft 122 includes a propulsion system 412 that includes engines 414, for example. Optionally, the propulsion system 412 may include more engines 414 than shown. The engines 414 are carried by wings 416 of the aircraft 122. In other examples, the engines 414 may be carried by a fuselage 418 and/or an empennage 420. The empennage 420 may also support horizontal stabilizers 422 and a vertical stabilizer 424.

The fuselage 418 of the aircraft 122 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. As described herein, the aircraft 122 includes various exterior surfaces on which one or more artificial ice layers 112 (shown in FIGS. 1-3) can be secured.

Alternatively, instead of an aircraft, the system and method as described herein can be used with various other vehicles, such as automobiles, buses, locomotives and train cars, watercraft, spacecraft, and the like, wind turbine blades, engines, and/or the like.

Further, the disclosure comprises examples according to the following clauses:

Clause 1. A method for testing an aircraft within a wind tunnel, the method comprising:
integrally forming roughness components with a substrate to provide an artificial ice layer.

Clause 2. The method of Clause 1, wherein said integrally forming comprises additively manufacturing the substrate and the roughness components.

Clause 3. The method of Clauses 1 or 2, wherein said integrally forming comprises using a three-dimensional (3D) printer to provide the artificial ice layer.

Clause 4. The method of any of Clauses 1-3, wherein the roughness components are not separately secured to the substrate after the substrate is formed.

Clause 5. The method of any of Clauses 1-4, further comprising providing a digital model of an artificial ice component, wherein said integrally forming comprises integrally forming the roughness components with the substrate according to the digital model.

Clause 6. The method of Clause 5, further comprising scanning, by a 3D scanner, the artificial ice layer.

Clause 7. The method of Clause 6, further comprising:
receiving, by a control unit, scanned data of the artificial ice layer from the 3D scanner; and
performing a quality check of the artificial ice layer by comparing the scanned data with the digital model.

Clause 8. The method of Clause 7, further comprising showing, by the control unit, a result of the quality check on an display of a user interface.

Clause 9. The method of any of Clauses 1-8, further comprising securing the artificial ice layer to one or more surfaces of the aircraft.

Clause 10. The method of Clause 9, further comprising performing a test of the aircraft within the wind tunnel.

Clause 11. The method of any of Clauses 1-10, wherein the roughness components comprise spaced-apart cones outwardly extending from the substrate.

Clause 12. A method for testing an aircraft within a wind tunnel, the method comprising:
providing a digital model of an artificial ice component; and
integrally forming roughness components with a substrate to provide an artificial ice layer according to the digital model, wherein said integrally forming comprises using a three-dimensional (3D) printer to additively manufacturing the substrate and the roughness components.

Clause 13. The method of Clause 12, wherein the roughness components are not separately secured to the substrate after the substrate is formed.

Clause 14. The method of Clauses 12 or 13, further comprising scanning, by a 3D scanner, the artificial ice layer.

Clause 15. The method of Clause 14, further comprising:
receiving, by a control unit, scanned data of the artificial ice layer from the 3D scanner; and
performing a quality check of the artificial ice layer by comparing the scanned data with the digital model.

Clause 16. The method of Clause 15, further comprising showing, by the control unit, a result of the quality check on an display of a user interface.

Clause 17. The method of any of Clauses 12-16, further comprising securing the artificial ice layer to one or more surfaces of the aircraft.

Clause 18. The method of Clause 17, further comprising performing a test of the aircraft within the wind tunnel.

Clause 19. The method of any of Clauses 12-18, wherein the roughness components comprise spaced-apart cones outwardly extending from the substrate.

Clause 20. A method for testing an aircraft within a wind tunnel, the method comprising:
providing a digital model of an artificial ice component;
integrally forming roughness components with a substrate to provide an artificial ice layer according to the digital model, wherein said integrally forming comprises using a three-dimensional (3D) printer to additively manufacture the substrate and the roughness components, wherein the roughness components comprise spaced-apart cones outwardly extending from the substrate, and wherein the roughness components are not separately secured to the substrate after the substrate is formed;
scanning, by a 3D scanner, the artificial ice layer;
receiving, by a control unit, scanned data of the artificial ice layer from the 3D scanner;
performing a quality check of the artificial ice layer by comparing the scanned data with the digital model;
showing, by the control unit, a result of the quality check on an display of a user interface;
in response to the artificial ice layer passing the quality check, securing the artificial ice layer to one or more surfaces of the aircraft; and
performing a test of the aircraft within the wind tunnel.

As described herein, examples of the present disclosure provide an improved system and method of forming an artificial ice layer configured to be applied to a surface of an aircraft during testing, such as within a wind tunnel. Further, examples of the present disclosure provide an efficient and effective system and method of providing roughness to an artificial ice layer.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A method for testing an aircraft within a wind tunnel, the method comprising:
integrally forming roughness components with a substrate to provide an artificial ice layer.

2. The method of claim 1, wherein said integrally forming comprises additively manufacturing the substrate and the roughness components.

3. The method of claim 1, wherein said integrally forming comprises using a three-dimensional (3D) printer to provide the artificial ice layer.

4. The method of claim 1, wherein the roughness components are not separately secured to the substrate after the substrate is formed.

5. The method of claim 1, further comprising providing a digital model of an artificial ice component, wherein said integrally forming comprises integrally forming the roughness components with the substrate according to the digital model.

6. The method of claim 5, further comprising scanning, by a 3D scanner, the artificial ice layer.

7. The method of claim 6, further comprising:
receiving, by a control unit, scanned data of the artificial ice layer from the 3D scanner; and
performing a quality check of the artificial ice layer by comparing the scanned data with the digital model.

8. The method of claim 7, further comprising showing, by the control unit, a result of the quality check on an display of a user interface.

9. The method of claim 1, further comprising securing the artificial ice layer to one or more surfaces of the aircraft.

10. The method of claim 9, further comprising performing a test of the aircraft within the wind tunnel.

11. The method of claim 1, wherein the roughness components comprise spaced-apart cones outwardly extending from the substrate.

12. A method for testing an aircraft within a wind tunnel, the method comprising:
providing a digital model of an artificial ice component; and
integrally forming roughness components with a substrate to provide an artificial ice layer according to the digital model, wherein said integrally forming comprises using a three-dimensional (3D) printer to additively manufacturing the substrate and the roughness components.

13. The method of claim 12, wherein the roughness components are not separately secured to the substrate after the substrate is formed.

14. The method of claim 12, further comprising scanning, by a 3D scanner, the artificial ice layer.

15. The method of claim 14, further comprising:
receiving, by a control unit, scanned data of the artificial ice layer from the 3D scanner; and
performing a quality check of the artificial ice layer by comparing the scanned data with the digital model.

16. The method of claim 15, further comprising showing, by the control unit, a result of the quality check on an display of a user interface.

17. The method of claim 12, further comprising securing the artificial ice layer to one or more surfaces of the aircraft.

18. The method of claim 17, further comprising performing a test of the aircraft within the wind tunnel.

19. The method of claim 12, wherein the roughness components comprise spaced-apart cones outwardly extending from the substrate.

20. A method for testing an aircraft within a wind tunnel, the method comprising:
providing a digital model of an artificial ice component;
integrally forming roughness components with a substrate to provide an artificial ice layer according to the digital model, wherein said integrally forming comprises using a three-dimensional (3D) printer to additively manufacture the substrate and the roughness components, wherein the roughness components comprise spaced-apart cones outwardly extending from the substrate, and wherein the roughness components are not separately secured to the substrate after the substrate is formed;
scanning, by a 3D scanner, the artificial ice layer;
receiving, by a control unit, scanned data of the artificial ice layer from the 3D scanner;
performing a quality check of the artificial ice layer by comparing the scanned data with the digital model;
showing, by the control unit, a result of the quality check on an display of a user interface;
in response to the artificial ice layer passing the quality check, securing the artificial ice layer to one or more surfaces of the aircraft; and
performing a test of the aircraft within the wind tunnel.
